(19) United States
(12) Patent Application Publication
(10) Pub. No.: US 2005/0021175 A1
(43) Pub. Date: Jan. 27, 2005

(54) Automated prescription dispensing system and method of use

(76) Inventor: Walter M. Bain, Farmington, UT (US)

Correspondence Address: RANDALL B. BATEMAN;BATEMAN IP LAW GROUP, 4 TRIAD CENTER, SUITE 825, PO BOX 1319, SALT LAKE CITY, UT, 84110, US

(21) Appl. No.: 10/755,849

(22) Filed: Jan. 12, 2004

Related U.S. Application Data
(63) Continuation of application No. 09/655,704, filed on Sep. 6, 2000, now abandoned.

(51) Int. Cl. G06F 17/00

(52) U.S. Cl. 700/236

(57) ABSTRACT

An automated prescriptions dispensing system includes a patient interface portion, a dispensing portion and a control portion. The dispensing portion holds and dispenses medication. The control portion tracks the medication and controls dispensing and the patient interface portion enables a patient to input information to cause the medication to be dispensed. The control portion can also be used to verify refill prescriptions which exceed the number originally authorized. It can also be used to send information to a central processing station which fills the prescriptions and returns them to the local pharmacy.

### BACKGROUND OF THE INVENTION

1. Field of the Invention

The present invention relates to a system and method for dispensing medications without the necessity of a pharmacist being present at the time the medications are dispensed. More particularly, the present invention relates to such a system which allows patients to pick up medication when a pharmacy is closed, or busy, while maintaining security measures to ensure that medications are delivered only to the appropriate patient.

2. State of the Art

The dispensing or delivery of prescription medications is an extremely large business in most countries. While it is important for patients to be able to obtain their prescriptions, the hours of operation of the pharmacy provides a limitation for many people. In some communities, pharmacies are only open from 9 a.m. until 5 p.m. For those who work or who depend on others to transport them to the pharmacy, these hours are often inconvenient and interfere with work schedules.

In other communities, the pharmacies are often placed in grocery stores to provide more flexible hours. Keeping the pharmacy open extended hours usually provides significant revenues for the store, since patients usually shop while picking up their prescriptions. Even with the extended hours, there are patients who find it inconvenient to make it to the store while the pharmacy is open. Furthermore, in many communities there are an insufficient number of pharmacists to keep local pharmacies open extended hours.

Even if the patient is able to get to the pharmacy during its regular hours, there are times during which the pharmacy is extremely busy. A busy pharmacy can cause the patient to wait a considerable amount of time to obtain a needed prescription. This is particularly frustrating for those who are merely obtaining a refill of their medication and do not require counseling about the use of the medication and possible interactions.

Having a busy pharmacy not only inconveniences patients, it also places considerable pressure on the pharmacist and any staff. When a large number of people are waiting, there is considerable pressure to fill prescriptions quickly. Of course, attempting to fill prescriptions quickly raises the risk that the prescription will be filled inaccurately. In many locations, two pharmacists are required to run the pharmacy due to periodic busy periods and the need to counsel patients who are filling new prescriptions. During other times, however, there is no need for two pharmacists, and having two present decreases the profitability of the pharmacy.

In addition to the above, local pharmacies are increasingly under competitive pressure from mail-order pharmacies. For those who require numerous refills of a prescription, it is often more convenient for the patient to order their medication from a mail order pharmacy. The medications are delivered to the patient by mail, rather than requiring the patient to go to the store during certain hours. Additionally, the mail order pharmacies have significant cost advantages because they have less patient interface and are able to purchase medications at lower prices due to bulk purchasing power. Unless local pharmacies are able to provide more convenience to patients, patients will increasingly shift from local pharmacies to mail order pharmacies.

Thus, there is a need for an improved mechanism for dispensing medications. Such a mechanism should allow patients to order and obtain medications after traditional pharmacy hours, and provide improved prescription dispensing even during pharmacy hours. Such a mechanism should also ensure that prescription delivery is controlled and that proper billing takes place.

### SUMMARY OF THE INVENTION

Thus, it is an object of the present invention to provide an improved prescription dispensing system.

It is another object of the present invention to provide an improved prescription dispensing system which enables patients to obtain their medications after conventional pharmacy hours.

It is another object of the present invention to provide an improved prescription dispensing system which enables patients to obtain their medications during normal pharmacy hours without taking the time of pharmacy staff.

It is another object of the present invention to an improved prescription dispensing system which ensures that the proper medications are delivered to the appropriate patient and which prevents over loading of the dispensing system.

It is yet another object of the present invention to provide an improved prescription dispensing system which provides medication counseling to patients.

It is still yet another object of the present invention to provide such a prescription dispensing system which can automatically verify the refill requested on a medication.

It is still yet another object of the present invention to provide a computer controlled prescription dispensing system which tracks medication storage and dispensing.

It is still another object of the present invention to provide multiple safeguards against patients receiving the wrong prescription.

The above and other objects of the invention are realized in specific illustrated embodiments of a medication dispensing system including an automated medication dispensing system including a patient interface portion, a medication holding portion, and a control portion which controls a dispensing mechanism for releasing the filled prescription from the medication holding portion to the patient interface portion. The patient is then able to retrieve the prescription from the patient interface portion.

In accordance with one aspect of the invention, the patient interface includes a data interface for entering information, such as the patient's name, telephone number and/or a person identification number. The data interface is disposed in communication with the control portion to ensure that each prescription is dispensed to the proper person.

In accordance with another aspect of the present invention, the patient interface portion includes a display screen which conveys information to the patient, such an counseling information regarding the medication and potential side effects and/or drug interactions. The counseling may either by in printed text, or a video of a pharmacist explaining proper use of the medication. A printer may also be provided for printing counseling or other information for the patient to take. Furthermore, a speaker may also be provided for giving counseling information to those who are visually impaired.

In accordance with another aspect of the present invention, the patient interface also includes a medication dispensing trough or receptacle. The trough is configured to allow the patient to receive his or her medication, while preventing anyone from reaching into the dispensing portion and obtaining the medications of others.

In accordance with another aspect of the present invention, the dispensing portion includes a plurality of dispensing slots (or other forms of medication holding receptacles) configured for receiving and dispensing medication for a number of different people. The dispensing slots are preferably configured to prevent accidental dispensing of medication contained therein. Additionally, the dispensing slots are preferably provided with doors or other safety devices which prevent medications from being loaded into the wrong dispensing slots. Furthermore, the dispensing slots preferably have sensors which confirm whether medication is present in the slot.

In accordance with another aspect of the invention, the control portion is disposed in communication with the patient interface portion and the dispensing portion. When a patient enters the appropriate information, the control portion checks the information and communicates with the dispensing portion to dispense the medication. As the medication is dispensed, the control portion preferably records the dispensing of the medication and generates a bill to the patient or patient's insurance company.

In accordance with another aspect of the invention, the control portion monitors the dispensing portion and selectively opens the dispensing slots to ensure that the appropriate medication is contained in the appropriate slot. Furthermore, the control portion can monitor the slots to generate reports as to what prescriptions have been dispensed and which have not. Those prescriptions which have not been dispensed within some predetermined period of time can then be removed and mailed to the patient or held for pick-up.

In accordance with yet another aspect of the invention, the control portion can also track the number of refills which a patient has received and automatically contact a doctor's office to confirm refills beyond the number originally prescribed. If authorized, the control portion can notify the pharmacist to fill the prescription and load it in the dispensing portion. If the additional refills are not authorized, the control portion can notify the patient of the need to see the doctor through the patient interface.

In accordance with still another aspect of the present invention, the control portion can be configured to transmit prescriptions to a central processing station where specialized filling equipment and procedures can reduce the time required to fill the prescription. Additionally, because the central processing station can order in much larger quantities than individual pharmacies, the central processing station is in a much better position to negotiate discounts on medications with the suppliers or otherwise obtain discounts for buying in bulk.

Once the prescriptions have been filled at the central processing station, they can be delivered to individual pharmacies and loaded in the automated medication dispensing system, where it may be retrieved by the patient. If the medication is a narcotic or other controlled substance, the medication can also be maintained in the pharmacy for pick-up.

### BRIEF DESCRIPTION OF THE DRAWINGS

The above and other objects, features and advantages of the invention will become apparent from a consideration of the following detailed description presented in connection with the accompanying drawings in which:

FIG. 1 shows a diagram of an automated medication dispensing system in accordance with the principles of the present invention;

FIG. 2 shows a partial side cross-sectional view of the patient interface portion and the dispensing portion, along with the control portion, of the automated dispensing system of the present invention;

FIG. 3 shows a rear view of the dispensing portion of the automated dispensing system of the present invention;

FIG. 4 shows a close-up, cross-sectional view of a dispensing slot formed in accordance with the principles of the present invention;

FIG. 5 shows an alternate configuration of a dispensing slot formed in accordance with the principles of the present invention;

FIG. 6 shows a diagram of a process for loading and dispensing medication in accordance with the present invention;

FIG. 7 shows a diagram of a process for verifying refill requests in accordance with the present invention;

FIG. 8 shows a diagram of a process for billing patients for the medication; and

FIG. 9 shows a diagram for filling high volume prescriptions at a central location to decrease drug and processing costs.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

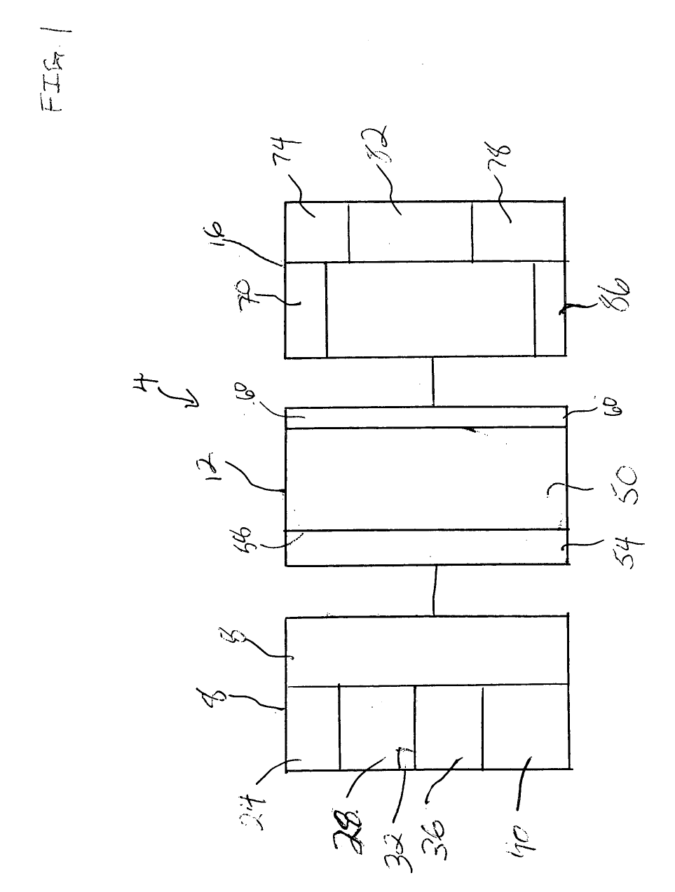

Referring to FIG. 1, there is shown is shown a functional diagram of an automated medication dispensing system, generally indicated at 4, made in accordance with the principles of the present invention. The automated medication dispensing system 4 includes a patient interface portion 8, a dispensing portion 12 disposed in communication with the patient interface portion, and a control portion 16 in communication with the other two.

The patient interface portion 8 includes a data interface 24 for entering information, such as the patient's name, telephone number and a personal identification number to ensure that the medication is being delivered to the proper person. Most commonly, the data interface 24 will be a keyboard for inputting information. However, the data interface 24 could be a magnetic or other type of card reader which accesses credit card/debit card information, or medical information stored on a card carried by the client. If properly configured, the automatic dispensing system 4 could even record information on the patient's card regarding prescriptions which would subsequently allow the automated dispensing system to warn the patient of possible interactions between a plurality of medications.

The data interface 24 may also include other means for verifying a person's identity. For example, a fingerprint scanner, or a retinal scanning device could be used prior to dispensing of medications containing narcotics.

The patient interface portion 8 also preferably includes a display screen 28 for conveying information to the patient. The display screen 28 can be used in conjunction with the data interface 24 for confirming information entered by the patient. The display screen 28 can also be used for showing counseling information regarding the medication and potential side effects and/or drug interactions associated with the medication.

If desired, a speaker 32 may also be associated with the display screen. The speaker 32 enables those with visual impairments or poor reading skills to obtain medication counseling even if they are unable read information on the display screen. The speaker 32 also enables counseling via a video presentation. Of course head phones (not shown) may be provided to enable patients to adjust the sound without bother those nearby. Headphones also enable those receiving certain medications to obtain counseling without informing those nearby of the medication the person is using. This may be of particular concern to those being treated for certain social diseases, impotence, or other conditions about which people are sensitive.

The patient interface portion 8 may also include a printer 36. The printer 36 can print out counseling information about the medication if desired by the patient, but would avoid the necessity of attaching printed counseling material with every prescription refill. Many patients will be sufficiently familiar with the proper use of a certain type of medication after several refills that they will not need to receive the same counseling information yet again. In the event that there is an update to the information about a medication, however, the automated medication delivery system could be configured to automatically print the new information while the patient is waiting for his or her medication to be dispensed. The printer can also be used to print receipts for patient co-payments, etc.

The patient interface portion 8 also includes a prescription dispensing receptacle, such as a trough 40. The prescription dispensing trough 40 is configured to allow the patient to receive his or her medication after the appropriate information is entered through the data interface 24. The medication dispensing trough 40 is also preferably configured to prevent anyone from reaching into the dispensing portion 12 and obtaining the medications of others. As will be discussed below, there are a variety of mechanism, such as swinging doors and slot placement which can be used to prevent unauthorized removal of prescriptions.

Disposed in communication with the patient interface portion 8 is the medication dispensing portion 12. The medication dispensing portion 12 includes a medication holding area 50 which is typically formed by a plurality of medication receiving slots. (As used herein, receiving slots are intended to cover bins and other medication receiving structures which temporarily hold the prescription prior to dispensing to the patient) If desired, sensors may be disposed in the slots to ensure that the medication is properly loaded.

Disposed adjacent the medication receiving area 50 is a medication release chamber 54 through which the medication falls as it moves from the medication receiving slots to the trough 40. There is typically a control mechanism, such as a movable dispensing gate or door 58, disposed between any one of the slots and the medication release chamber 54 to control release of the medication.

The opposing side of the medication holding area 50 also preferably includes an access control mechanism 60. The access control mechanism 60 is configured to prevent medication for two different patients from being disposed in the same medication receiving slot. While the access control mechanism 60 will typically be a door for selectively closing each receiving slot, other mechanisms for controlling access to the receiving slots can be provided.

Disposed in communication with the medication dispensing portion 12 is the control portion 16. The control portion 16 typically includes a processor 70. Information is entered into the control portion 16 by data interface 74, which will typically be a keyboard. The data interface 74 is used to input information about patients, prescriptions and billing into the processor 70.

A bar code scanner 78 or similar mechanism can also be used to input information into the processors. As will be explained in additional detail below, the bar code scanner 78 allows the pharmacist or technician to scan information on each prescription immediately before the prescription is loaded into one of the medication receiving slots of the medication holding area 50. (It is already customary in some pharmacies to print prescription labels with bar codes). The processor 70 stores this information and subsequently accesses the appropriate medication receiving slot when the appropriate information is entered through the data interface 24 of the patient interface portion 8.

The control portion 16 also preferably contains a display monitor 82. The display monitor 82 allows the user to monitor information he or she is entering into the processor 70. Additionally, the display monitor 82 enables the user to review reports and other information generated by the processor 70 or related devices.

The control portion 16 also preferably includes a remote communications interface 86. The remote communications interface 86 can be configured to accomplish numerous tasks. At its simplest level, the remote communications interface 86 acts as an answering machine and receives information from patients about the medications which they need to obtain. This information may be manually entered, or may be automatically entered with a voice recognition system, which can subsequently be reviewed by a pharmacist or technician. In the alternative, the communications interface 86 may allow information to be entered through touch-tone.

The communications interface 86 can also be used to contact doctors' offices to confirm whether a patient may have a refill which exceeds the number originally prescribed. When the patient calls in the prescription, the processor 70 or user determines if the number of allowed refills has been met. If so, the communications interface 86 calls the doctor's office and inquires as to whether the doctor will authorize further refills. If so the processor 70 will store the appropriate information. If the doctor's office indicates that the refill should be denied, or indicates that the refill can be filled but requests that the patient come in for a check-up, the processor 70 can convey the information to the patient through the patient interface portion 8 when the patient comes to retrieve the prescription, or the communications interface 86 will call the patient with a message that he or she needs to visit the doctor.

The communications interface 86, which may operate via recorded message, or via electronic message, such as E-mail, is advantageous to both the pharmacy and the doctor's office. First, rather than requiring a pharmacy employee to call the doctor's office and wait for a reply, the communications interface 86 automatically sends the needed information to the doctor's office. Second doctor's office is then able to reply at a convenient time, such as before patients start coming for the day or during other slow periods. Third, the request for further refills and the instructions from the doctor's office may be readily recorded by both the pharmacy and the doctor's office. This is far better than simply relying on oral communications between technician's and the doctor's staff, and takes less time than making notes regarding the oral communications.

Preferably, the communications interface 86 and the doctor's office will communicate over a secured line, whether it be telephonically or electronically. The secure line will greatly minimize the risk of patients attempting to obtain unauthorized refills on pain and other times of medication by providing falsified prescriptions, etc.

If desired, the communications interface 86 could even be configured to verify all prescriptions or to receive initial prescriptions over the secured line. Because the doctor can directly relay prescription information to the patient's pharmacy of choice, there is no need to use the conventional prescription pad. Unfortunately, prescription pads are often stolen by those seeking to improperly obtain narcotics and other pain medications. By eliminating the need for a prescription pad, the doctor no longer has to deal with falsified prescriptions bearing his or her name. Furthermore, the communications interface could also be accessed by remote pharmacies so that patients could replace lost prescriptions while on vacation, etc.

In addition to communications with patients and doctors' offices, the communications interface 86 can also be used to communicate information about prescriptions to a centralized processing station. In such a station, all prescriptions for a given medication can be filled by a particular technician, approved by the pharmacist and then be prepared for transport to the appropriate pharmacy. Because the technician can fill all of the prescriptions for a given medication at a particular time, he or she is able to process the prescriptions more quickly and accurately than a technician who may be filling prescriptions for a wide variety of drugs within a short period of time. Additionally, because a central processing station may be used for a large number of pharmacies, the central processing station may purchase medications in bulk and obtain significant discounts on the cost of the medication. Furthermore, because many of the orders are filled off site, the local pharmacies can keep smaller amounts of certain medications on hand with little risk that they will be unable to fill patient's prescriptions when needed.

Once the prescriptions are filled, they are transported to the individual pharmacies. The prescriptions can then either be manually dispensed by the pharmacist, or loaded into the automated dispensing system 4. If an individual submits a prescription for filling or refilling prior to midnight, the prescription can be fully processed and to the pharmacy prior to regular business hours of the next day. In addition to cutting costs, it also lessens the work load on the pharmacist and technicians during busy parts of the day and enables the pharmacist to spend more time counseling patients on the proper use of their medication.

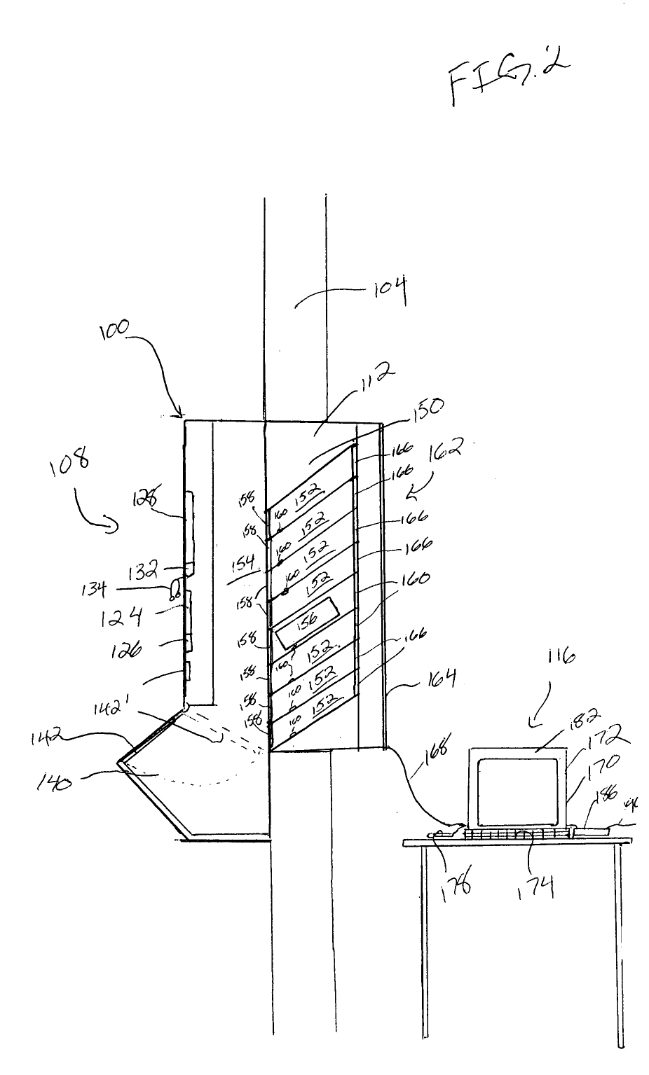

Turning now to FIG. 2, there is shown a partial side, cross-sectional view of automated medication dispensing system 100 mounted in a pharmacy wall 104 and made in accordance with the principle of the present invention.

The automated medication dispensing system 100 includes a patient interface, generally indicated at 108, a dispenser, generally indicated at 112, and a controller 116. The patient interface 108 includes a data interface 124, in the form of a key board, for entering information, such as the patient's name, telephone number and a personal identification number to ensure that the medication is being delivered to the proper person. The data interface 124 may also include a magnetic card reader 126 which can be used for credit card/debit card charges, or to access medical information stored on a card carried by the patient.

The patient interface 108 also preferably includes a display screen 128 for conveying information to the patient. The display screen 128 can be used in conjunction with the data interface 124 for confirming information entered by the patient. The display screen 128 can also be used for showing counseling information regarding the medication and potential side effects and/or drug interactions associated with the medication.

One advantage with displaying counseling information on the display screen is that the patient can be provided extensive, controlled counseling information about the medication. While pharmacists attempt to provide patients with thorough counseling information, there are times when the number of patients waiting places limitations on the time that the pharmacist can spend with each patient. The pharmacist may give very brief counseling or may inadvertently omit information about possible drug interactions. The information provided via the display screen 128, however, can provide more thorough information and can ensure than important information is conveyed or updated whenever needed.

A speaker 132 may also be provided. The speaker 132 enables those who are visually impaired or illiterate to receive appropriate instructions on use of the medication. Head phones 134 enable the user to listen to information without allowing others to hear information about the patient's medication.

The patient interface portion 108 may also include a printer 136. The printer 136 enables the patient to take information about the proper use of the medication if requested. The printer 136 could also be instructed to automatically print updated information about a medication. The printer 136 can also be used to print receipts.

Those skilled in the art will also appreciate that the display screen 128 and/or the printer 136 can be used to dispense counseling information about medication in languages other than English. Thus, for example, if a patient is not proficient in English, the pharmacist could send the patient to the patient interface 108 for counseling in the patient's native language. While few pharmacists know more than one or two languages sufficiently to provide counseling, the display screen 128 and/or printer 136 could provide pre-translated counseling in hundreds of languages.

The patient interface 108 also includes a medication dispensing receptacle, such as trough 140, which is configured to allow the patient to receive his or her prescription after the appropriate information is entered through the data interface 124.

The medication dispensing trough 140 preferably has a door 142 of other device which is configured is also preferably configured to prevent anyone from reaching into the dispensing portion 112 and stealing medications. As shown in FIG. 2, the door 142 swings into a position 142′ in which is prevents access to the dispensing portion 112. Similar security could be provided by a movable wall which isolated the dispensing portion 112 when the door 142 is opened. Alternatively, the dispensing portion 112 could be configured in such a way that a person's hand could not reach any medications contained therein.

Disposed adjacent to the patient interface portion 108 is the dispenser 112. The medication dispenser 112 includes a medication holding area 150 which is typically formed by a plurality of medication receiving slots 152 which are positioned adjacent a medication release chamber 154 which feeds into the trough 140. Those skilled in the art will appreciate that there are a wide variety of ways to hold the medication prior to dispensing and receiving slots as used herein is intended to cover such configurations.

As shown in FIG. 2, the medications receiving slots 152 are disposed at an incline so the medication 156 disposed therein will slide out of the receiving slot when an dispensing control mechanism 158, such as a door, retractable bar or similar device, is moved to an open position. The dispensing control mechanism 158 also helps to ensure that medications 156 are not pulled out of the receiving slots 152.

When a patient enters the correct information in the data interface 124 of the patient interface 108, the dispensing control mechanisms 158 for each receiving slot 152 containing that patient's medication will open. This enables all of the medications for that particular patient to be dispensed at once. Of course, the dispensing control mechanisms could be controlled to open only to specific request. Thus, a patient could input his or her information and then select which medications he or she wants to have delivered. However, as space will typically be at a premium in the dispensing portion 112, it is undesirable to keep medications in the dispensing portion for any length of time. Thus, simultaneous dispensing of all of patient's medications is preferred.

In light of the present disclosure, those skilled in the art will appreciate that the receiving slots 152 may be sufficiently large to hold all of patient's medication, or be configured only to hold a single prescription. Thus, a single door 158 may be opened or a plurality of doors may be opened in response to the information entered by the patient.

Each of the receiving slots 152 also preferably has a sensor 160 associated therewith. The sensor 160 is configured to determine whether medication is disposed in the receiving slot 152. Those skilled in the art will appreciate that numerous types of sensors, such as optical sensors, pressure sensors and the like, may be used.

The purpose of the sensor is to determine the presence of the medication in the receiving slot. If a dispensing door 158 has been actuated, the medication should fall from the receiving slot and be distributed to the patient. If the sensor 160 detects medication 156 in the receiving slot, however, after the dispensing door 158 is closed, the control portion 116 can generate an alarm that the medication has not been properly been distributed. This enables the pharmacist to remove the medication prior to loading additional medication in the receiving slot 152. Thus, a patient will not accidently get the wrong medication because medication meant for another was retained in the receiving slot 152 when the control portion 116 thought it has been dispensed.

The dispenser 112 also preferably includes an access control mechanism 162. The access control mechanism 162 preferably includes a main door 164 which controls access to the medication holding area 150, and a plurality of receiving slot access doors 166 which limit access to the individual access receiving slots 152. Those skilled in the art will appreciate that other structures such as bars, gates, etc. which selectively limit access to the receiving slots can also be used.

While the main door 164 controls access to the medication holding area 150 and is preferably locked, the receiving slot access doors 166 are preferably opened and closed by the control portion 116. As will be explained in detail below, the receiving slot access doors 166 prevent a pharmacist or technician from accidentally placing medication in the wrong receiving slot 152. Preferably, the controller 116 will open a receiving slot access door when the technician desires to load the machine. Information about the prescription is entered into the machine from a data interface (discussed below) of the controller 116. Once the prescription 156 is disposed in the appropriate receiving slot 152, as determined by the sensor 160, the controller automatically associates the relevant information about the prescription with the particular receiving slot into which it is was placed. The controller 116 closes the receiving slot access door 166. The control portion 116 then opens the receiving slot access door for the next available slot. In such a manner, the risk that the wrong medication will be delivered to the patient is virtually eliminated.

The patient interface portion 108 and the dispensing portion 112 are controlled by the controller 116 which may be in communication with the patient interface and the dispenser via a telephone line 168, conventional networking cables, or a transmitter/receiver. The controller 116 includes a processor 170, which is typically in the form of a personal computer 172. Information is entered into the computer 172 by data interface or keyboard 174, although other forms of data entry may also be used.

The pharmacist or technician can use the keyboard 174 to manually enter information about the prescription, the patient, etc., or the computer can be configured to receive the information directly from the patient or physician. It is important that the information be entered properly, as the controller 116 can also be used to generate bills to the patient or the patient's insurance company when the prescription is filled or when the filled prescription is dispensed.

A bar code scanner 178 or similar mechanism can also be used to input information into the controller. When the prescription is filled, a label is generated for attachment to the bottle. The label will preferably include a bar code or other method of providing information to the computer 172. Immediately prior to placing the medication 156 into the receiving slot 152, the pharmacist or technician scans the medication and the computer 172 reads the information on the bar code. Once the medication 156 is received in the receiving slot 152, as indicated by the sensor 160, the computer 172 knows that the medication has been loaded in that particular receiving slot and closes the appropriate access door 166. When the patient enters the proper information into the data interface 124 of the patient interface portion 108, the computer 172 sends a signal opening the dispensing door 158 for that particular receiving slot 152 and causes the medication 156 to be dispensed.

Once the medication 156 has been loaded and the access door 166 closed, the computer 172 will then open the access door for the next available receiving slot. Each time the pharmacist or technician will scan the medication 156 and plate it in the now open receiving slot 152 and the access door 166 will close. By opening a single access door 166 at a time, the computer 172 is able to carefully track the medication 156 which is disposed in each receiving slot 152.

As the computer 172 performs its functions, the information regarding the patient and the prescription will preferably be displayed on the display monitor 182. If the information display suggests an error, the pharmacist or technician is able to instruct the computer to open the access door 166 for confirmation of the information. Periodic reports on medication dispensing and other information may also be viewed on the display screen 182.

The controller 116 also preferably includes a remote communications interface 186. The remote communications interface 186 may be formed integrally with the computer 172, or may be a stand alone modem or processor. The remote communications interface 186 can be configured to accomplish numerous tasks which greatly expand the capabilities of the automatic medication dispensing system 100.

At its simplest level, the remote communications interface 186 may be simply an answering machine which records prescription requests. Each morning, a pharmacist or technician listens to the messages and either fills the prescriptions immediately, or enters them into the computer or some other task organizer for filling at a later time.

In more advanced systems, the information from the communications interface 186 could be automatically entered into the computer 172. Automatic entry could occur via a voice recognition system with manual confirmation, or a touch-tone information system in which the patient can use a telephone to enter the information regarding his or her prescription.

In addition to obtaining information from patient's desiring prescriptions to be filled, the communications interface 186 can also be used to receive or confirm prescriptions from doctors' offices, and to confirm whether a patient may have a refill which exceeds the number originally prescribed. Rather than writing a prescription on his or her prescription pad, the doctor can simply have an assistant call or electronically communicate the prescription to the pharmacy.

If the automated medication dispensing system 100 is authorized to dispense original prescriptions, the computer 172 can inform the technician that the prescription is to be filled and placed in the system (if desired by the patient). If the automated medication dispensing system 100 is not authorized to dispense original prescriptions based on state regulatory requirements, the computer 172 can inform the technician to prepare the medication and have it ready at the counter.

The communications interface 186 can also be used to confirm a prescription which the technician or pharmacist believes may not be genuine, or to request a doctor's authorization to fill a prescription which exceeds the number originally indicated by the doctor. By confirming such matters electronically, less burden is placed on both the doctor and the pharmacist.

It will be appreciated by those skilled in the art that the communications interface 186 will preferably be configured to have secured communications with doctor's offices. There are a variety of methods for creating secured lines 190, such as those commonly used with wide-area networks. By limiting access to the communications interface 186, the control portion 116 prevents non-physicians from improperly obtaining medications by providing false information to the computer 172.

While the controller 116 is shown in FIG. 2 as being somewhat isolated from the patient interface 108 and the dispenser 112, those skilled in the art will appreciate that the controller or any portion thereof could be disposed within the housing containing the patient interface portion and the dispenser. Additionally, individual processors could be used in the interface portion 108 and the dispensing portion 112 for overseeing the tasks managed by that those portions of the system.

Turning now to FIG. 3, there is shown a rear view of the dispenser 112 of the automated dispensing system 100 shown in FIG. 2 with the door 164 open to reveal the receiving slots, a representative sample of which is represented by numeral 152. Each of the receiving slots 152, except receiving slot 152a, is closed by an access door 166. On slot 152a, the access door 166a has been moved into an open position to allow medication to be inserted into the slot.

Disposed between the receiving slots 152 are a plurality of actuators 190. The actuators 190 are configured to selectively open the dispensing door 158 and the access door 166 to control the placement of prescription in and release of the prescription from the receiving slots 152. By controlling the movement of the actuators 190, the controller 116 is able to regulate when medication is dispensed from a receiving slot 152, and when the access door 166 opens to allow the receiving slot to be filled with medication for a different patient. Preferably, the controller 116 will allow only one access door 166 to be open at a time, thereby preventing the pharmacist or technician from accidentally placing medication in the wrong receiving slot 152.

In contrast, a plurality of the dispensing doors 158 can open simultaneously to release all of the patient's medications if such is desired. Of course, the control portion 116 can be programmed to open only one dispensing door 158 at a time, so that each medication is dispensed individually. Such a dispensing protocol would be most desirable if the patient was receiving one or more new prescriptions and needed counseling on that prescription.

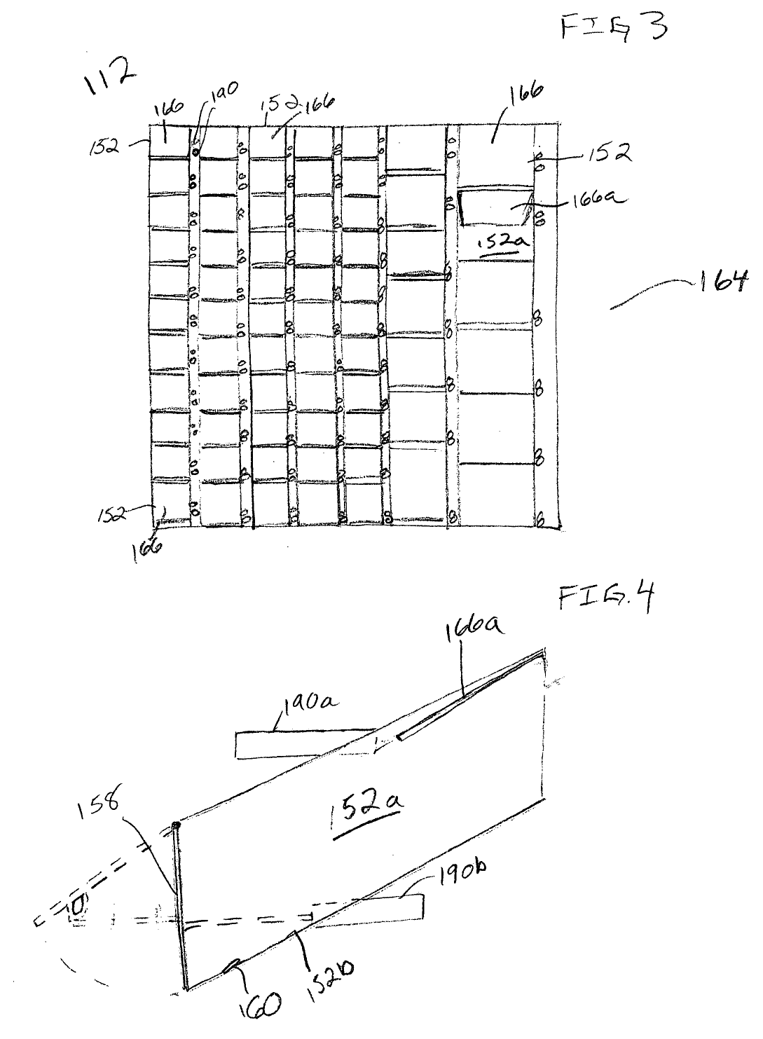

Turning now to FIG. 4, there is shown a close-up, cross-sectional view of the receiving slot 152a. As shown in FIG. 4, the receiving slot 152a is in a loading configuration in which the access door 166a has been moved to the open position by actuator 190a, and the dispensing door 158a and actuator 190b remain closed. In the present configuration, it is preferred that each door 166a and 158a is biased closed, so that power failure will not allow accidental loading or accidental dispensing of medication.

While FIG. 4 shows the use of pistons 190a and 190b as actuators, those skilled in the art will appreciate that there are numerous different mechanical and electrical actuators which can be used to selectively open and close the doors. Which actuator is best depends on the configuration of the receiving slots and other electrical and mechanical considerations.

Once medication has been loaded into the receiving slot 152a, it will slide downwardly along the sloped bottom wall 152b until it contacts the dispenser door 158a. The presence of the medication in the receiving slot 152b is confirmed by the, sensor 160, and the access door 166a closes. When the patient enters the necessary information, the dispenser door 158a opens, allowing the medication to slide out and fall into the trough 140. The absence of the medication is confirmed by the sensor 160 and the controller 116 confirms that the medication has been delivered. If the controller 116 includes a billing protocol, the controller may then generate a bill to the insurance company and/or charge the credit card of the patient for any co-payment due.

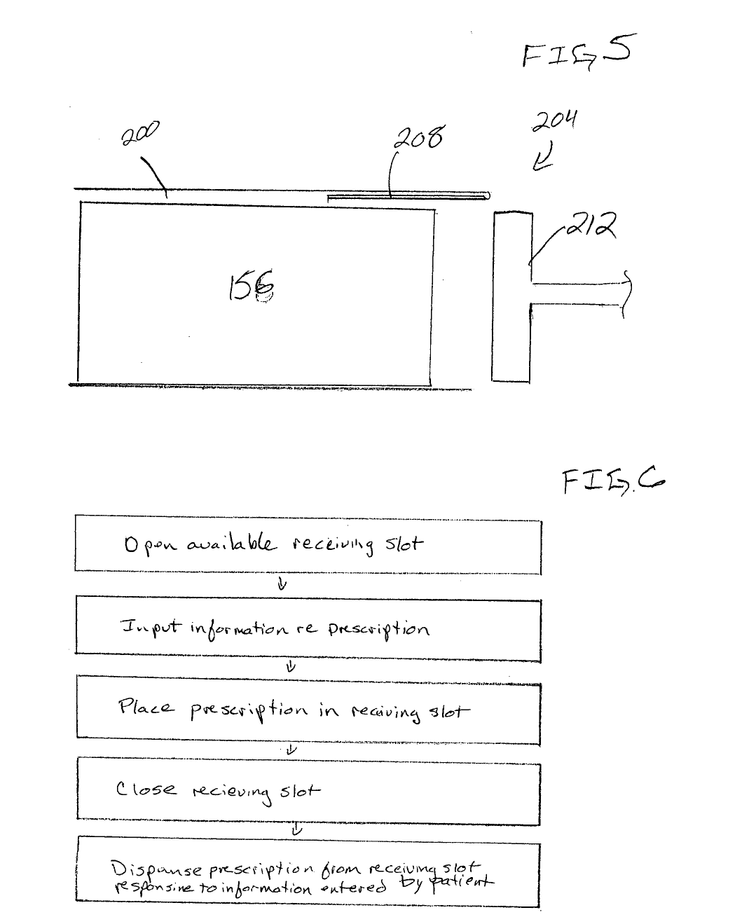

While the configuration shown in FIGS. 2 through 4 is a presently preferred embodiment, those skilled in the art will appreciate that there are numerous different configurations for holding and dispensing the medication which fall within the scope of Applicant's invention. For example, FIG. 5 shows a cross-sectional view of an alternate configuration of the receiving slot 200 and dispensing mechanism, generally indicated at 204.

The receiving slot 200 is provided with a door 208 which is biased in a closed position. While not shown in FIG. 5, the door 208 will typically have a number written thereon. When a receiving slot 200 is empty, the door 208 will hang vertically, informing the user that the medication 156 can be placed in that slot.

During loading, the technician or pharmacist will see that slot X is empty and enter the number of the box into the computer. The information regarding the prescription is then scanned or typed into the computer and the medication is placed in that receiving slot 200.

When the patient enters the appropriate information, the control portion actuates a piston 212 to extend into the receiving slot 200 and to push the medication 156 out the receiving slot and into the trough (not shown). The movement of the piston 212 also releases the door 208. The door 208 returns to its original position, thereby signifying to the pharmacist or technician that the receiving slot 200 is again ready for use.

While the configuration of FIG. 5 lacks the numerous redundancies of the embodiment shown in FIGS. 2 through 4, it is still sufficiently reliable to properly dispense medication to patients. It should be understood that both of these configurations are mere samples of the many different manners in which the medication can be held and dispensed in accordance with the principles of the present invention.

FIG. 6 shows the steps of preferred process for loading and dispensing medication in accordance with the present invention. Initially, the pharmacist of technician will prompt the controller by entering information regarding the number of receiving slots needed. The computer of the controller scan its data base and determines how many of each size of receiving slot is available. The pharmacist or technician then requests the number of each receiving slot size needed and hits enter. The control portion then automatically calls for the number of receiving slots, one at a time, by requesting receiving slot size. The computer then automatically opens an access door.

The pharmacist or technician loads the prescription by scanning the bar code information into the computer and then placing the medication in the open receiving slot. If the receiving slot is sufficiently large and the computer is properly programmed, the computer will accept several prescriptions being placed into the particular receiving slot. In such a situation, the access door will remain open until the pharmacist or technician indicates that all of the prescriptions for that receiving slot have been loaded. The access door will then close and the medication is ready for dispensing.

In the alternative, the computer can be programed so that only a single prescription can be placed in each receiving slot. Once the medication has been placed in the receiving slot and its presence confirmed by the sensor, the access door will automatically shut. The pharmacist or technician then moves on to the next prescription.

Once the medication is disposed in the receiving slot, it may be obtained by the patient by entering the appropriate information. For example, the patient may enter his or her telephone number and a personal identification number. The computer correlates these two numbers and determines which receiving slot(s) has medication for that patient. The computer then causes the dispensing door(s) to open, thereby dispensing the medication.

Because the computer has all of the information regarding a prescription correlated with the prescription's location, the computer can identify the location of the prescription immediately. If for some reason the prescription needs to be changed, the pharmacist accesses the computer and simply request the computer to open the access door or dispensing door for the receiving slot having that prescription. Once either door is opened, the prescription can be removed and replaced, etc.

Because space in the dispenser is valuable, it is disadvantageous for prescriptions to remain in the dispensing portion for a prolonged period of time. Thus, it is preferred that the computer track the time that each prescription has been in the receiving slot. If a prescription has been in the dispenser for more than some predetermined threshold, ie. three days, the computer will generate the report that the prescription has exceeded the time limit. The computer can then automatically dispense all such prescriptions to the technician and the prescriptions can either be mailed to the patient or the prescription containers opened and the medication returned to their respective containers.

While the exact steps of the method for loading and dispensing medication will depend on state regulatory requirements and the sophistication of the system, those stilled in the art will appreciate that they will include the basic elements of placing medication in a receiving slot (or a bin or other similar structure), recording information about the prescription to associate the receiving slot with the patient, and entering information correlated to the patient to cause the medication to be dispensed. An example protocol for the embodiment shown in FIGS. 2 through 4 is as follows, with the receiving slots being referenced as bins:
1. LOADING: The Pharmacist must first PROMPT the computer controlling the delivery machine by entering the number of “bins” to be loaded. The computer then scans its' data base to see how many of each sized bines are available. The pharmacist then requests that number of each bin sizes needed and hits enter. The computer will then automatically “call” for the number of bins, one at a time, by requested bin size. The computer will “auto open” and “auto assign the Rx location in the RAPID REFILL CENTER machine”.
2. The Pharmacist will “load” the bin by scanning the “name of customer” (existing bar code label on smiths Rx) found on the prescription label, and then placing the Prescription(s) into the open bin. The computer then prompts the pharmacist to “type” in the # of prescriptions in each bine associated with this order, and the “customer co-pay” amount(s), and the customers personal pin #. On prescriptions which are called in but are unavailable to refill, the computer must have a default key to indicate that there are prescriptions ordered by not filled yet. The customer at time of pickup must then be notified that some number of prescription(s) were not filled, at this time but will be by ______ (date shown). This information must be known to the pharmacist to be entered into the computer for the customer to be notified. (When the pharmacist loads the machine, he can prompt the machine to display a message about any prescription). Upon completing the requested information the Pharmacist hist the “finished key”; the COMPUTER closes the open bin which has just been loaded, and then automatically opens the next bin. The Pharmacist starts the data entry all over again, until the pharmacist has loaded all of the prescriptions. “With the “bin open” the computer links the customers name, and prescription number, and totals the co-pay amounts, and links all of these to the open “bin location” automatically”. Any duplicate customer name in the data base would bring up all customers with the same name in a “scroll down highlighted file layout”. The customer name file must link with other data files: a. the customers phone number. b. the customers personal identification #. d. all of the customer billing information (credit card #, or checking account info). All five (name, phone#, and pin#, and Rx#, billing info) must appear side by side to allow the pharmacist to distinguish which “JOHN DOE” is the correct JOHN DOE. When the pharmacist finds the correct JOHN DOE, the enter key is pressed upon the highlighted line thus choosing the correct customer. When the pharmacist selects the correct customer and the “enter” key is depressed, the correct customer then has the link between a specific location inside the machine and the customer located there. At the time the customer arrives at the dispensing side of the machine, the computer must link the phone number and the pin# to the bin location, and display the Rx#s on the screen with their associated co-pay amounts, with the total co-pay amount to be charged to the customer.
3. If when the pharmacist scans the bar coded name of the customer on the Rx label, and this is a customer that is not currently entered in the files in the computer then the computer must prompt the pharmacist to stop and enter all of the specific customers information. After all required elements are typed, then the computer “saves” all of the information.
4. The Rapid Refill Center machine computer and dispensing unit must also act as a security device for insuring that the correct customer receives the correct prescription. The computer must therefore recognize and cross check all information given (by Pharmacist and by customer). After the computer actuates the R.R.C. machine to move the open bin into the closed or “store position”; the customer is able to request the prescription from the customer side of the machine.
5. When the customer addresses the machine, to retrieve a prescription the computer screen on the front (linked to the main computer data base) will have a “START” key to be depressed which will prompt the customer to enter his/her phone number (the computer will search the data base for the entered phone number), after entering the phone#, then the computer asks the customer to enter his/her personal pin#, if the phone number and the pin# match, then the computer will display the prescription#s as entered by the pharmacist, with their individual co-pay amounts, and total co-pay amount; then the computer prompts a response from the customer “is this correct” Y N. If the customer chooses “no”, then the machine will not deliver any Rx, and will display a message “please see the Pharmacist”, and goes back to a reset position. If the customer chooses “yes” then the Prompt Script computer activates the dispensing portion of the machine, which allows the Rx to drop onto the conveyor belt and actuates the conveyor belt to move the Rx past the internal bar code readers and if the Rx is the correct one, then is delivered to the dispensing bin; and the screen then tells the customer that his/her Rx has been billed to his credit card or checking account (DO NOT DISPLAY CREDIT CARD INFORMATION, OR CHECKING ACCOUNT INFORMATION). If there is an incorrect cross check, upon the conveyor system, then the Rx is routed to the holding bin and a message appears on the customer screen “please see pharmacist”.
6. When the Rx is delivered to the customer, then the C.P.U. sends the billing impulse to the Bank processing center for the co-pay amount to be billed to the customer.

### REPORTS

1. By date and time, when customers Rx is loaded in the bin; when the Rx is delivered, and the phone number and personal pin # used to retrieve the Rx.
2. Aging report of any Rx remaining in the machine from the previous day.
3. Any prescriptions not delivered successfully (held by the computer) to be redone. This information would automatically appear in a scroll down screen basis to be cleared out and redone.
4. Data base needs to be backed up nightly, and every 90 days needs to be purged to a backup file by date (Iomega Zip type system). Those skilled in the art will appreciate that numerous modifications can be made to such protocols depending on the system layout, state regulations on medication dispensing and the desired reports regarding filling and dispensing descriptions.

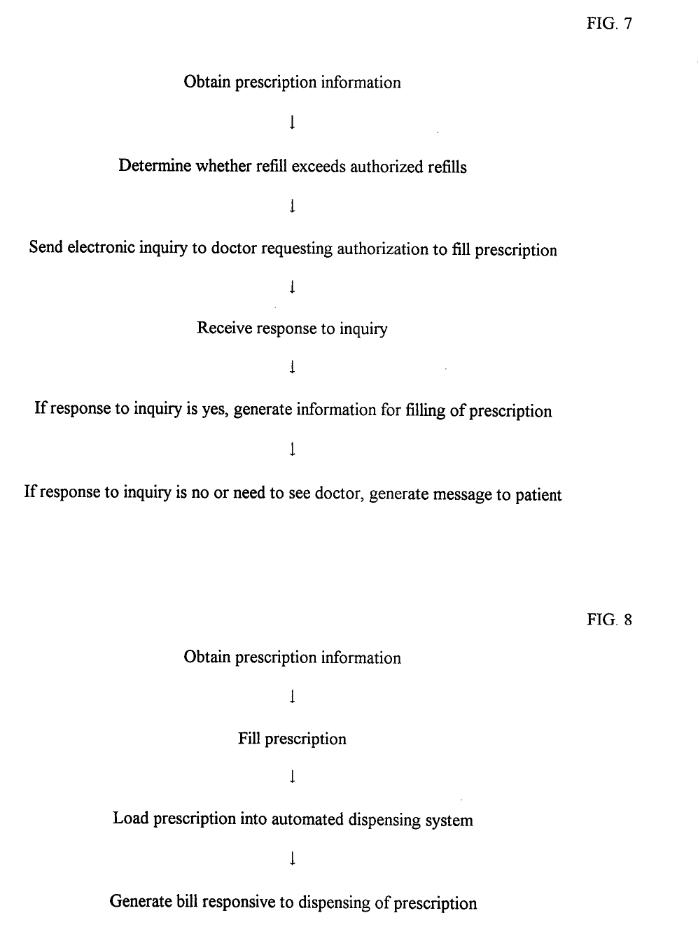

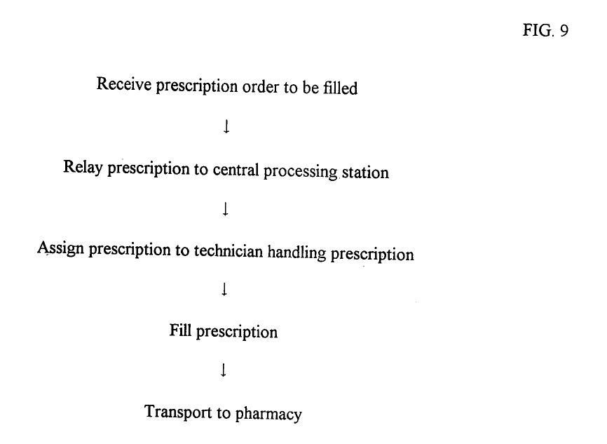

Turning now to FIG. 7, there is shown a diagram of a process for verifying refill requests in accordance with the present invention. It is common for patients who are on long-term medications, such as high blood pressure pills, heart medication, and the like, to seek refills on prescriptions even after the number of refills listed on the initial prescription has been met. Because the patients usually need the medication and there is little risk that further refills will cause problems, it is common for pharmacists to call doctors to obtain authorization for additional refills. While such a procedure saves unnecessary doctor's visits, it does take time for both the pharmacy and the doctor's office for someone to call asking for authorization for the refill, and someone to return the call. Often, these calls must be exchanged at the busiest times of day.

In accordance with one aspect of the present invention, the communications interface 186 (FIG. 2) is used to send an electronic message to the doctor's office requesting authorization to refill the prescription. The pharmacy saves time because the computer generates and sends the electronic message instead of requiring a technician to make the call and wait on the telephone. The doctor's office saves time because the requests can be answered before opening or at other times when the doctor is not with patients. Additionally, records can be generated directly from the electronic communications, rather than requiring additional time of office staff.

If the doctor is not willing or authorize a refill or will authorize a refill but wishes to see the patient, the computer can also generate a message for the patient informing the patient that he or she needs to contact the doctor. This may be particularly helpful for those who have problems remembering to schedule appointments or who are otherwise difficult to reach.

In addition to obtaining authorization for refills, this same system can be used by doctors to submit prescriptions to the pharmacy. The doctor is able to avoid the use of a prescription pad (which is prone to being stolen) and records regarding the prescription can be automatically generated. This a further benefit to the pharmacy because the prescription can be automatically entered into the computer. Additionally, the risk of mistake due to illegible prescriptions is reduced, thus reducing liability.

Finally, by placing the appropriate information in an electronic format, the ability of patients to have prescriptions filled at remote locations is also enhanced. If the computer from one pharmacy contacts the computer at another pharmacy regarding a refill, the patient is able to get the needed medication and the computer at the home pharmacy is able to automatically adjust the number of remaining refills for the patient. This would allow a network of pharmacies to more accurately track patient prescriptions while providing improved access for patients.

Turning now to FIG. 8, there is shown the steps for billing a patient and/or an insurance company for the medication. One hassle which technicians often face is generating bills when prescriptions are filled or picked up. In accordance with the present invention, bills can be generated when the call is made for a refill by the patient providing his or her credit card number. There are, however, pharmacies that prefer not to bill the client for the prescription until the prescription has actually been received. If billed in advance and the prescription is not picked up, the pharmacy must submit reimbursements to the insurance company. This causes considerable work for the pharmacist or technicians.

Because the computer controls dispensing of the medication in the present invention, the computer is also able to either take credit card payment at the time of receipt, and/or to generate bills to the patient's insurance company upon dispensing of the medication. By billing based on dispensing of the medication rather than based on the ordering, the pharmacy can demonstrate that the medication was, in fact, received by the patient and avoid unnecessary paperwork and reimbursements.

The automated prescription dispensing system of the present invention also makes the use of a central processing station more feasible. The call for a prescription can be made either the pharmacy or to a centralized number. The prescription information is then collected at a central processing station and assigned to various technicians based on the medication involved.

While one pharmacy may fill two prescriptions in a day for an heart medication, another pharmacy may fill twenty prescriptions for the same medication. There are medication counting machines than can rapidly count the number of pills dispensed. However, if a technician is filling only a couple of that prescription, it is often not efficient to use the pill counting machines.

By using a central processing station, however, all of the prescriptions for a certain drug may be processed by a single technician. A processing station for all the pharmacies for a large grocery chain may fill dozens of prescriptions for a particular drug. A technician concentrating on a single medication could use the counting machine to fill all of the prescriptions in much less time than the aggregate of the technicians at each of the local pharmacies.

Using a central processing station decreases the number of technicians necessary at each pharmacy and reduces the cost of the medication. Additionally, the prescriptions can be filled over night and delivered to the pharmacy prior to opening, so that the medication can be placed in the automated prescription dispensing system, or simply held at the pharmacy. Thus, the central processing station is able to be cost competitive with mail order companies, while allowing the patient to obtain their medication the next morning, rather than several days later.

While ideally all of the different systems and methods described herein are used in conjunction with one another, each may be used independently to improve the processing of prescriptions. Each aspect of the invention improves patient access to their medications, while simultaneously providing increased efficiency and/or profit for the pharmacy or doctor.

Thus there is disclosed an improved automated S medication dispensing system. Those skilled in the art will appreciate numerous modifications which can be made without departing from the scope and spirit of the present invention. The appended claims are intended to cover such modifications.

1. An automated prescription dispensing system comprising:
a patient interface having a data interface configured for entering information correlated to the patient and a receptacle through which medication is dispensed;
a dispenser disposed in communication with the patient interface portion for holding and dispensing medication; and
a controller in communication with the dispensing portion for selectively controlling the dispensing of medication disposed in the dispensing portion.

2. The automated prescription dispensing system of claim 1, wherein the data interface comprises a keyboard.

3. The automated prescription dispensing system of claim 1, wherein the data interface comprises a magnetic card reader.

4. The automated prescription dispensing system of claim 1, wherein the patient interface further comprises a display screen.

5. The automated prescription dispensing system of claim 1, wherein the patient interface further comprises a speaker.

6. The automated prescription dispensing system of claim 1, wherein the patient interface further comprises a printer.

7. The automated prescription dispensing system of claim 1, wherein the dispenser comprises a plurality of medication receiving slots.

8. The automated prescription dispensing system of claim 7, wherein the dispenser comprises at least one door disposed adjacent each receiving slot for selectively controlling the passage of medication through the dispenser.

9. The automated prescription dispensing system of claim 8, wherein the at least one door comprises an access door for selectively preventing placement of medication into the receiving slot.

10. The automated prescription dispensing system of claim 8, wherein the at least one door comprises a dispensing door for selectively releasing medication from the receiving slot.

11. The automated prescription dispensing system of claim 7, further comprising a plurality of sensors for determining the presence of medication within the plurality of receiving slots.

12. The automated prescription dispensing system of claim 7, wherein the controller is configured to track the location of medication disposed in one of the plurality of receiving slots.

13. The automated prescription dispensing system of claim 1, wherein the control comprises a data interface for entering information about each prescription loaded into the dispenser.

14. The automated prescription dispensing system of claim 13, wherein the data interface comprises a keyboard.

15. The automated prescription dispensing system of claim 13, wherein the date interface comprises a scanner.

16. The automated prescription dispensing system of claim 1, wherein the controller comprises a processor programed to record information regarding the location of medications within the dispenser.

17. The automated prescription dispensing system of claim 1, wherein the controller further comprises a communications interface for communicating with remote locations.

18. A method for automated prescription dispensing comprising:
filling a prescription by obtaining a container with medication therein;
loading the prescription into a dispenser; and
dispensing the prescription to a patient in response to input of data correlated to the patient.

19. The method according to claim 18, wherein method comprises placing the prescription into a receiving slot of a dispenser having a plurality of receiving slots disposed therein.

20. The method according to claim 19, wherein the method comprises correlating a receiving slot in which the prescription is placed with information regarding the patient.

21. The method according to claim 20, further comprising releasing the prescription from the dispenser in response to input of data correlated to the patient.

22. The method accord to claim 18, wherein the method comprises dispensing the prescription after the patient has entered a personal identification number.

23. A method for dispensing medication from a dispenser having a plurality of receiving slots, the method comprising:
opening an available receiving slot;
inputting information regarding a prescription;
disposing the prescription in the receiving slot;
closing the receiving slot; and
dispensing the prescription from the receiving slot to a patient.

24. A method for verifying a refill prescription, the method comprising:
obtaining information regarding a prescription to be refilled;
determining whether a new refill exceeds an authorized number of refills; and
sending an electronic inquiry to a doctor requesting an authorization to fill a refill prescription which exceeds the authorized number of refills.

25. The method according to claim 24, wherein the method further comprises receiving an electronic authorization confirmation from a doctor.

26. The method according to claim 25, further comprising filling the prescription in response to the electronic authorization confirmation.

27. The method according to claim 24, wherein the method further comprises receiving an electronic denial of confirmation and generating instructions for a patient to contact the doctor.

28. A method for billing prescriptions, the method comprising:
filling a prescription;
loading the prescription into an automated dispensing system;
dispensing the prescription to a patient in response to information correlated to the patient; and
generating a bill responsive to dispensing of the prescription.

29. A method for more efficiently filling prescriptions, the method comprising:
collecting information for a plurality of prescriptions at a central processing location;
filling the prescriptions; and
transporting the prescriptions to a plurality of local pharmacies.

30. The method according to claim 29, wherein the method comprises receiving prescription information at local pharmacies and relaying the information to the central processing location.

31. The method according to claim 29, wherein the method comprises organizing the prescriptions into groups based on the medication prescribed and filling the prescriptions by group.

32. The method according to claim 29, further comprising loading the prescriptions into an automated dispensing system at the local pharmacy.
